(19) United States
(12) Patent Application Publication
(10) Pub. No.: US 2013/0047236 A1
(43) Pub. Date: Feb. 21, 2013

(54) AUTHENTICATION SYSTEM AND METHOD THEREOF

(71) Applicant: Jasbir Singh, Inzlingen (DE)

(72) Inventor: Jasbir Singh, Inzlingen (DE)

(21) Appl. No.: 13/639,934

(22) PCT Filed: Sep. 29, 2010
(86) PCT No.: PCT/EP10/64488

§ 371 Date: Oct. 11, 2012

(30) Foreign Application Priority Data
Apr. 9, 2010 (EP) EP2010/054729
Jul. 17, 2010 (CH) 00974/10

(51) Int. Cl. G06F 21/00

(52) U.S. Cl. 726/7

(57) ABSTRACT

The invention relates to a system and method for authentication of subscribers of a system (1), wherein an authentication key (1200) of a subscriber (10) is transmitted from an input unit (30) to an authentication unit (40) of the system (1), and wherein the subscriber (10) is authenticated by the authentication unit (40) based on the transmitted authentication key (1200) by means of saved authentication data (120), wherein each of the authentication keys is composed of a subset of a predefined authentication character (1201) set, wherein the system (1) dynamically generates a multidimensional visual representation (190) by geometrically arranging authentication characters of the authentication character (1201) set comprising successive characters of the authentication key (1200), and displays said multidimensional visual representation (190) by means of an output unit (20), wherein first geometrical orientations (195) of pairs of successive characters of the authentication key (1200) within the visual representation (190) is determined by the subscriber (10) and that said first geometrical orientations (195) are entered by the subscriber (10) for each of the pair of successive characters of the authentication key (1200) by means of the input unit (30) of the system (1), wherein each of said entered geometrical orientation (196) is transmitted to the system (1) and second geometrical orientations are generated based on the visual representation, and wherein the first and second geometrical orientations are compared by means of the authentication unit (40), wherein on successful comparison the subscriber (10) is authenticated by means of the authentication unit (40).

The present invention relates to a method for authentication of subscribers of a system according to the preamble of the claim 1 and a corresponding system.

### BACKGROUND OF THE INVENTION

Determining a person's identification in an authentication process is well known, particularly authentication methods using username and password for authentication of a subscriber of a system.

A generally popular method of authentication of a subscriber is by requesting typically a four digit password, like “1234”, “1212” etc., e.g. to unlock the screen of a device such as a mobile phone, or by using such a four digit password for a credit card, or banking card to withdraw money at a cash machine, also referred to automated teller machine (ATM). Said password is also known as personal identification number (PIN) used together with a personal identification device (PID).

Another method used to authenticate a user to a system is by evaluating the input of the subscriber using gestures or by following a predefined path e.g. on a touch screen or on a computer screen using a mouse as input device.

One of the drawbacks of such methods is that once a third person monitoring or keeping track of the subscriber's entry to its PID, ATM or internet portal, the password is directly unveiled, since the subscriber enters what he knows, respectively remembers. Generally it is observed, that in the end either a password that can be copied or recorded easily if filmed or the key strokes and/or display is being saved. Even tracks of grease from fingerprints can be recovered from a touch screen after having entered typical gestures to unlock a device.

In general with the spread of CCTV's, cameras, video cameras, hardware tampering of terminals and key/screen trapping technologies, it will happen that the subscriber's password and/or PIN will be recorded. Hence a better method must take this into consideration and not be easy to detect the user's secret even when recorded a number of times.

### TECHNICAL OBJECT

It is an object of this invention to provide a new and better authentication system and method, which does not have the disadvantages of known systems, in particular to provide a fraud save authentication method.

It is yet another object of this invention to provide a simple authentication method, which is easy to use with existing input devices of desktop and mobile devices, such as ATM, personal computers, laptops, mobile phones—particularly smart phones etc.

It is another object of the invention to be able to use a simple to use and remember but strong and not easy to break method of creating a one-time-passcode or -password.

Furthermore it is an object of the invention to provide a user authentication which can be used as a stand-alone system or in combination with another system.

It is yet an object of this invention to provide a scalable, respectively modular authentication system and method.

### SUMMARY OF THE INVENTION

According to the present invention, these objects are achieved particularly through the features of the independent claims. In addition, further advantageous embodiments follow from the dependent claims and the description.

Additional features and advantages will also become apparent to those skilled in the art upon consideration of the following detailed description of illustrative embodiments exemplifying the best mode of carrying out the method as presently perceived.

According to the present invention, the above mentioned objects are particularly achieved by a system and method for authentication of subscribers of a system, wherein an authentication key of a subscriber is transmitted from an input unit to an authentication unit of the system, and wherein the subscriber is authenticated by the authentication unit based on the transmitted authentication key by means of saved authentication data, wherein each of the authentication keys is composed of a subset of a predefined authentication character set, wherein the system dynamically generates a multidimensional visual representation by geometrically arranging authentication characters of the authentication character set comprising successive characters of the authentication key, and displays said multidimensional visual representation by means of an output unit, wherein first geometrical orientations of pairs of successive characters of the authentication key within the visual representation is determined by the subscriber and that said first geometrical orientations are entered by the subscriber for each of the pair of successive characters of the authentication key by means of the input unit of the system, wherein each of said entered geometrical orientation is transmitted to the system and second geometrical orientations are generated based on the visual representation, and wherein the first and second geometrical orientations are compared by means of the authentication unit, wherein on successful comparison the subscriber if the first geometrical orientation matches the second geometrical orientation.

One of the advantages of the invention is, that tracking of a users input, e.g. during a screen unlock of a smartphone or by entering an authentication key at an automated teller machine (ATM) for cash withdrawal, will hardly be of any use for the person tracking said input, since the user does not directly enter the displayed characters. The user or subscriber of a system does enter information, which is based on the displayed characters, images, pictograms and/or colors. The user takes the information displayed and adds additional information known to the user, such as an angle, direction, number or position and then performs an input to the system. The authentication system is therefore scalable with regard to complexity of the level of security added to the user interface.

In an embodiment of the invention, the said multidimensional visual representation is two dimensional, wherein characters of the visual representation are arranged in a table.

One of the advantages of the invention is that the typically sequential orientation of the authentication key or password is being transformed into a multidimensional representation or orientation such as a grid or table, wherein the displayed information in said orientation is highly legible, even for elderly people. A table of five by five characters is typically used. Larger tables result in a more secure authentication method. Smaller tables will offer better legibility, still providing a secure authentication method. Hence said system is scalable.

In another embodiment of the invention, said multidimensional visual orientation and/or representation of at least parts of the authentication character set consisting at least parts of the authentication key is three dimensional, respectively has three dimensions.

One of the advantages of the invention is that said scalability of the system towards a more secure authentication can be realized by having a visual orientation of characters e.g. displayed with a cube, which is rotatable in multiple directions using multiple axes.

In a further embodiment of the invention, the authentication character set is composed of alphanumerics, graphics and/or images.

One of the advantages of the invention is that the authentication character set is not limited to characters such as A to Z, a to z, including Umlauts, but may additionally or alternatively be composed of numerals 0 to 9, graphics, pictograms, images etc. An embodiment of the authentication system may provide a set of animals depicted graphically to the subscriber, e.g. for easier remembrance, or for children to authenticate to a music or games internet portal. Combinations of the described types of characters are possible.

In an embodiment of the invention, the geometrical arrangement of authentication characters in the multidimensional visual representation is randomly generated by means of the system.

One of the advantages of the invention is that the visual representation of the characters is arranged dynamically and randomly arranged. In this context dynamically is understood as being arranged by a specific point of time, typically when presenting or displaying the visual representation to the subscriber. Each time an authentication process starts, the visual representation is recreated and displayed from scratch. For each authentication process, consisting of one or multiple steps of entering first geometrical orientations, the characters are newly arranged by random. In other words, having a letter or character “T”, said character will be displayed e.g. in the most upper left cell of a table. In another authentication process, e.g. a day later, the letter “T” may be displayed in the same or another cell.

In another embodiment of the invention, the system displays a subset of pairs of successive characters of the authentication key.

One of the advantages of the invention is that typically the subscriber is asked to enter a geometrical orientation for any of the pairs of successive characters of the authentication key. For unlocking of a screen it may be sufficient, to request less than the maximum of pairs of successive characters, e.g. only two pairs. Such an embodiment of the invention therefore complies with the object of scalability.

In a further embodiment of the invention, the authentication key consists of identical successive characters of the authentication key, wherein only one of said characters is displayed within said multidimensional visual representation by the output unit of the system.

One of the advantages of the invention is that the visual representation e.g. on consists of a full set of characters, wherein each character displayed is unique. In a typical embodiment characters or letters A to Y are used to fill a grid or table of five by five cells. A third persons trying to guess or steal a passcode can not spot any irregularities in the representation, such as the existence of two identical letters like “I” and “I” of a passcode being “TGIIF”.

In an embodiment of the invention the subscriber typically selects a specific key or is performing a predefined gesture or swipe on a touch screen, e.g. a circle, to indicate to the system, that the pair of successive characters consists of two identical characters.

In an embodiment of the invention, said input unit is a touch screen.

One of the advantages of the invention is, that the visual representation can be in background to a touch sensitive area within said visual representation. In a typical example having a visual representation of five by five cells of a table, the inner three by three cells can be touch sensitive, wherein the subscriber uses said inner cells as input unit, e.g. to enter a swipe or to touch virtual keys representing geometrical orientations.

In a further embodiment of the invention, said input unit is an alphanumeric keypad and/or keyboard.

One of the advantages of the invention is, that the authentication system and method is not limited to implementations within a single device. Input and output unit may be physically separated embodiments, such as a screen and a keyboard. E.g. a display of a mobile phone can be used to display the virtual representation of the system, while the input unit may be the keyboard of an ATM.

In an embodiment of the invention, the system dynamically regenerates and displays the multidimensional visual representation after the subscriber has entered a first geometrical orientation.

One of the advantages of the invention is, that the level of security can be augmented by refreshing the displayed characters between each step of entering a first geometrical orientation by the subscriber.

### BRIEF DESCRIPTION OF THE DRAWINGS

The present invention will be explained in more detail, by way of example, with reference to the drawings in which:

FIG. 1a is a schematic illustration of a detail of a prior art system for authentication of a subscriber to said system, wherein the subscriber enters character by character of his authentication key using an input unit of the system and wherein the subscriber is authenticated by the authentication system, if the characters entered is equal to the predefined authentication key, which is saved by the storage unit of the system;

FIG. 1b is a schematic illustration of an embodiment of the inventive system for authentication of a subscriber to said system, wherein instead of characters, the subscriber enters a direction or geometrical orientation of characters of the authentication key known by the subscriber to avoid being spied;

FIGS. 2a to 2d showing the steps of entering geometrical orientations based on the authentication characters displayed by an output unit of an embodiment of the inventive system, wherein the subscriber enters each geometrical orientations of pairs of successive characters of the authentication key (FIG. 2e), e.g. “TGIIF”, using an input unit of the system, such as an touch sensitive pad or screen, wherein said input unit may be separated from the output unit;

FIGS. 3a to 3d showing the steps of entering geometrical orientations of pairs of successive characters using an embodiment of the inventive system, wherein the input unit consists of entry keys of a keypad or keyboard, dedicated to nine directions or geometrical orientations;

FIG. 4 is a schematic illustration of an embodiment of the inventive system, showing a smartphone displaying the authentication characters in a two dimensional array or table, consisting of 25 characters, wherein an area of 3 by 3 elements or keys are touch sensitive, for entering the geometrical orientations by the subscriber;

FIG. 5 is a schematic illustration of an embodiment of the inventive system, showing a smartphone, wherein an output unit displays randomly arranged characters in a two dimensional array or table, consisting of 25 unique characters, wherein the geometrical orientation from character “T” to character “G” of the authentication key is entered by steering a compass needle of the input unit of the system;

FIG. 6 is a schematic illustration of an embodiment of the inventive system, showing a smartphone, wherein an output unit of said smartphone displays the authentication characters in an less structured over the output unit of the system array or table;

FIG. 7 is yet another simplified schematic illustration of a user interface of an embodiment of the inventive system, wherein a cube is displaying a grid of five by five characters per side, wherein the cube is rotatable on eight axes, and wherein the subscriber selects and swipes the cube in the direction towards the succeeding character of the authentication key;

FIGS. 8a to 8c are schematic illustrations of the user interface of an embodiment of the inventive system, wherein the subscriber or user selects from the authentication key shown in FIG. 8d the succeeding color or shade, which is geometrically related to a preceding color or shade and wherein for an authentication key of three colors, the subscriber quickly selects each of the three succeeding colors, e.g. to unlock a screen of a device such as a smartphone;

FIGS. 9a to 9c are schematic illustrations of the user interface of an embodiment of the inventive system, wherein the subscriber enters a geometrical orientation of successive shades of an authentication key shown in FIG. 8d of three shades, e.g. to unlock a screen of a portable device such as a smartphone.

### DETAILED DESCRIPTION OF THE PREFERRED EMBODIMENTS

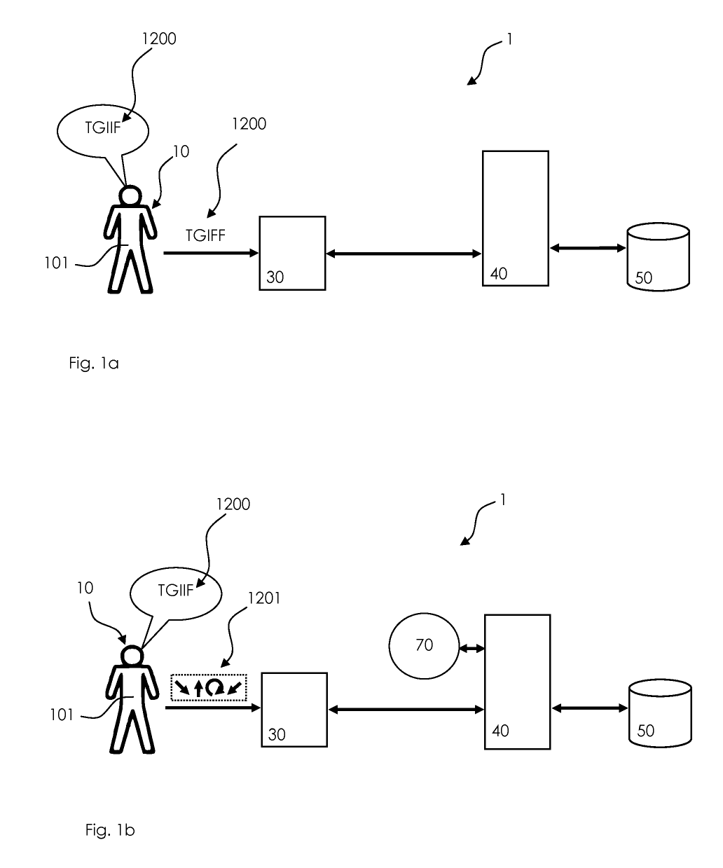

FIG. 1a illustrates a schematic illustration of a detail of a prior art system for authentication of a subscriber to said system, wherein the subscriber enters character by character of his authentication key using an input unit of the system and wherein the subscriber is authenticated by the authentication system, if the characters entered is equal to the predefined authentication key, which is saved by the storage unit of the system.

FIG. 1b illustrates a schematic illustration of an embodiment of the inventive system 1 for authentication of a subscriber to said system, wherein instead of characters, the subscriber enters a direction or geometrical orientation of characters of the authentication key known by the subscriber to avoid being spied. The authentication unit 40 of the system can be implemented as a separated, remotely working system, communicating with the user interface, at least consisting of an input unit 30 and an output unit 20. The authentication unit 40 may communicate with a separate geometrical unit or topology unit 70 for generating second geometrical and/or topological orientations based on the multidimensional visual representation of authentication characters. Said generation of second geometrical orientations may also be handled by the authentication unit 40 itself. A storing unit 50 of the system 1 is dedicated to save authentication data 120. It can also be used to save coordinates, cell information, vectors etc. of the characters displayed in the virtual representation 190. The authentication unit 40 is capable to transmit dedicated data to and receive from the storing unit 50. The topology unit 70 may also be adapted to directly bidirectional interact with the storing unit 50 for transmitting and receiving authentication data and/or representation vectors.

The system 1 dynamically generates a visual representation 190 of characters for each authentication process. An authentication process in this context means that a subscriber 10, known by the system 1 from an initialization step, will be requested to authenticate. The authentication process will be finished by either successfully authenticate said subscriber 10 or by e.g. denying any further input.

For said authentication process, a visual representation is regenerated dynamically. Each of the character of the authentication character 1201 set used for generating the visual representation is unique and used only once within said visual representation. The arrangement or position of each character in said visual representation is new for each authentication process. To provide a more secure authentication system, the visual representation may be regenerated for each step within the authentication process.

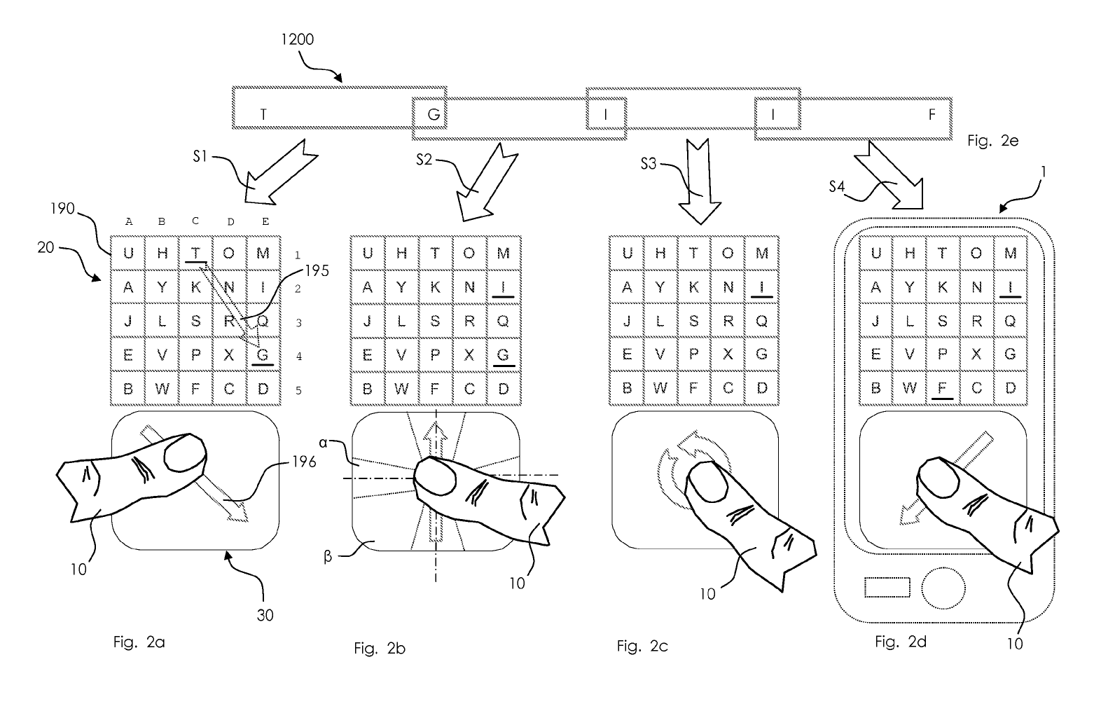

FIGS. 2a to 2d illustrate the steps of entering geometrical orientations based on the authentication characters displayed by an output unit 40 of the inventive system 1. The inventive system 1 is shown in FIG. 2d with dashed outline, such a mobile device. The subscriber 10 enters each geometrical orientations, here annotated with reference number 195 in FIG. 2a. Each pair of successive characters, as of the authentication key (FIG. 2e), e.g. “TGIIF”, using an input unit of the system, such as a touch sensitive pad or screen, wherein said input unit may be separated from the output unit.

For authentication of subscribers to the inventive system 1, an authentication key 1200 of a subscriber 10 is transmitted from an input unit 30 to an authentication unit 40 of the system 1, and wherein the subscriber 10 is authenticated by the authentication unit 40 based on the transmitted authentication key 1200 by means of saved authentication data 120. In an initialization process said authentication key 1200 may either be defined by the subscriber, e.g. by selecting characters, numeric, images or shades which are easy to remember, like the first characters “TGIIF” of the words “Thank God It Is Friday”, or “BRGY” of “Blue Red Green Yellow”.

Combination of characters, numeric, images and/or shades are possible.

In this context authentication character 1201 set consists of predefined characters, numeric, pictograms, images and/or shades, but is not limited to them. Each of the authentication keys 1200, shown in FIG. 2e, is composed of a subset of a predefined authentication character 1201 set, wherein the system 1 dynamically generates a multidimensional visual representation 190 by geometrically arranging authentication characters of the authentication character 1201 set comprising successive characters of the authentication key 1200, and displays said multidimensional visual representation 190 by means of an output unit 20.

In the embodiment of the inventive system 1 the 25 unique characters “A-Y” are used to generate a multidimensional visual representation, which consists of the characters “T”, “G”, “I” and “F” used for the authentication key 1200.

As further illustrated in FIG. 2a, the system dynamically arranges said 25 characters of the authentication key 1200 within a two dimensional grid or table, having five by five cells. Only for descriptive purpose the cell grid is numerated by “A to E” and “1 to 5”. The first character of the authentication key 1200 is located in the cell C1 and the second character “G”, which is successive to “T”, is located in the cell E4. Said two dimensional table is a typical multidimensional representation 190 of the system 1. The dashed arrow representing said first geometrical orientation is shown in this illustration for descriptive purpose only. Also the underlines used in the tables of FIGS. 2a to 2d are shown in those illustrations for descriptive purposes only. The frames in FIG. 2e are used to illustrate pairs of successive characters. The arrows depicted with S1 to S4 are representing steps of subscriber interaction and are used for descriptive purpose only. First geometrical orientations 195 of pairs of successive characters of the authentication key 1200 within the visual representation 190 is determined by the subscriber 10 and that said first geometrical orientations 195 are entered by the subscriber 10 for each of the pair of successive characters of the authentication key 1200 by means of the input unit 30 of the system 1.

In a first step S1, the subscriber 10 e.g. enters the geometrical orientation 195, visually perceptible to him from the table in FIG. 2a, by swiping over a touch screen or touch pad of said embodiment of the system from upper left to lower right, as illustrated in FIG. 2a. When initializing the authentication, a process which is not shown, an offset may be defined by the subscriber 10 or the system 1, whereas said offset is e.g. an angle, such as 180°, meaning that the subscriber does a the just described swipe into the opposite direction.

Each of said entered geometrical orientation 196 is transmitted to the system and second geometrical orientations are generated based on the visual representation, and wherein the first and second geometrical orientations are compared by means of the authentication unit 40, wherein on successful comparison the subscriber 10 is authenticated by means of the authentication unit 40.

The authentication unit 40 and/or the topology unit 70 of the system 1 generate second geometrical orientations based on the visual representation. In a typical embodiment each generated second geometrical orientation is a vector within a multidimensional space, as displayed within the table shown in FIG. 2a. A vector in said table is “C1; E4”, here represented with reference number 195, starts at character “T” and pointing to character “G”. Said vector of the second geometrical orientation can also represent an angle. The system 1 matches the first geometrical orientation entered by the subscriber 10 with the generated geometrical orientation for authentication. The matching method may be based on a reference table or may be a mathematical formula. The authentication unit may generate said matching.

For better legibility the visual representation realized as table or grid in the current embodiment of the inventive system 1 is not rearranged from step 1 to step 2 etc. That way, successive characters of the authentication key 1200 can be found easier by the subscriber. It is evident, that the system 1 may dynamically regenerate the 25 characters from one to the next step and randomly reorder said characters. This is one possibility to add complexity to said system. If the subscriber input will be tracked, a third person will not be able to successfully use said input in a further authentication process.

FIG. 2b, in step S2, illustrates a successive pair of characters “G” and “I”, which are underlined for descriptive purpose. The subscriber swipes with his finger vertically upwards. As illustrated, the subscriber tries to input the first geometrical orientation as exact as possible. The authentication unit 40 authenticates the subscriber, if the first geometrical orientation matches the second geometrical orientation. To provide a user tolerant entry method, an input is also accepted by the system 1, if e.g. the angle of the input differs from the expected entry by +/−10 degrees. Said angle is depicted with reference α. Any other angle, depicted with β, is e.g. about 70 degrees for accepting diagonal entries. Other angles may be defined by the system 1. In an initial step of registering the user to the authentication system, a matching routine may be used to train the system and register subscriber specific parameters. Such parameters may be speed of a key press, accuracy of a gesture, selecting reference points etc.

FIG. 2c, in step S3, illustrates a successive pair of identical characters “I” and “I”, which is underlined for descriptive purpose and can be found in cell A2 in FIG. 2c. Since the visual representation 190 only represents unique characters, the geometrical orientation in this case is made by pointing from said character to itself. The specific input entered by the subscriber 10 is by e.g. swiping with a circle with his finger. Also tapping onto the input unit 30 may be another implementation of said user input, but not limited to it.

FIG. 2d, in step S4, illustrates a successive pair of identical characters “I” and “F”. The inventive system in this embodiment is referenced with numeral 1. The subscriber 10 swipes diagonal from upper right to lower left to enter said first geometrical orientation between “I” and “F”, using the input unit of the system.

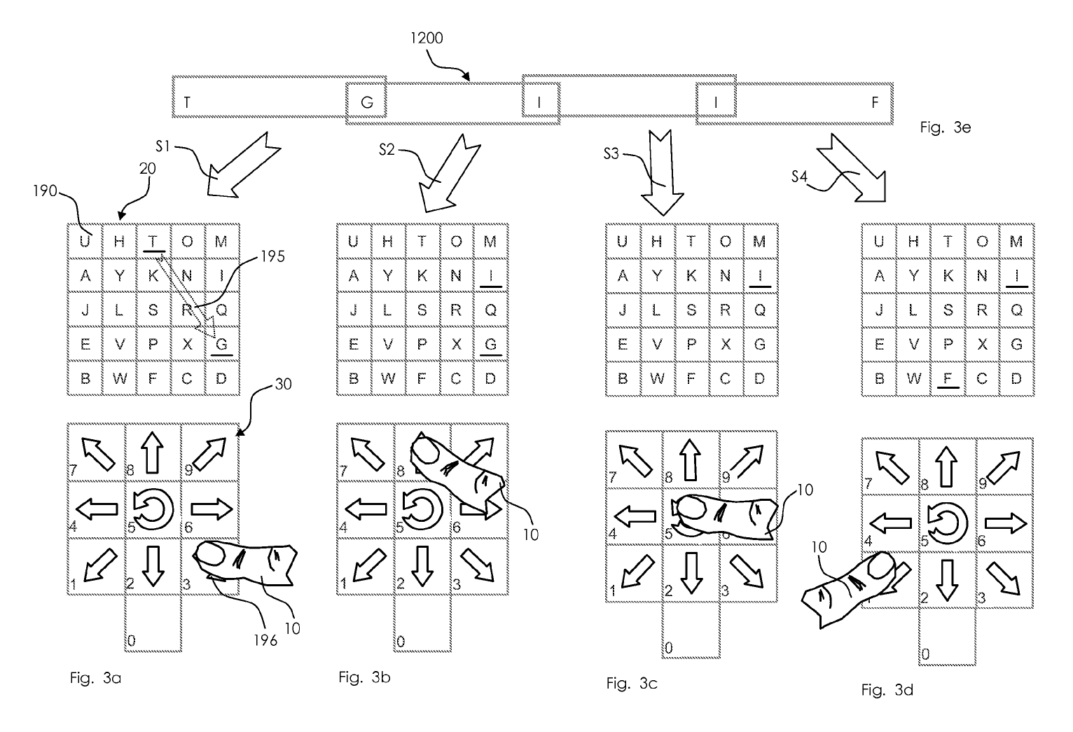

FIGS. 3a to 3e illustrate the steps of entering first geometrical orientations 195 of pairs of successive characters using the inventive system 1. The input unit 30 consists of entry keys of a keypad or keyboard, dedicated to nine directions or geometrical orientations. In FIG. 3a, the first geometrical orientation 195 of successive characters “T” to “G” of the authentication key 1200, being “TGIIF” is illustrated. Said orientation or relation is a direction or angle from upper left to lower right, or about diagonally downwards to the right. The subscriber is reading said first geometrical orientation and is trying to find an input element of the input unit 20 fitting the best to said orientation. The subscriber enters said orientation using a key having an arrow pointing diagonally downwards to the right. Instead of using a keypad, the subscriber could also use a keyboard writing down “down right” or “downwards right”.

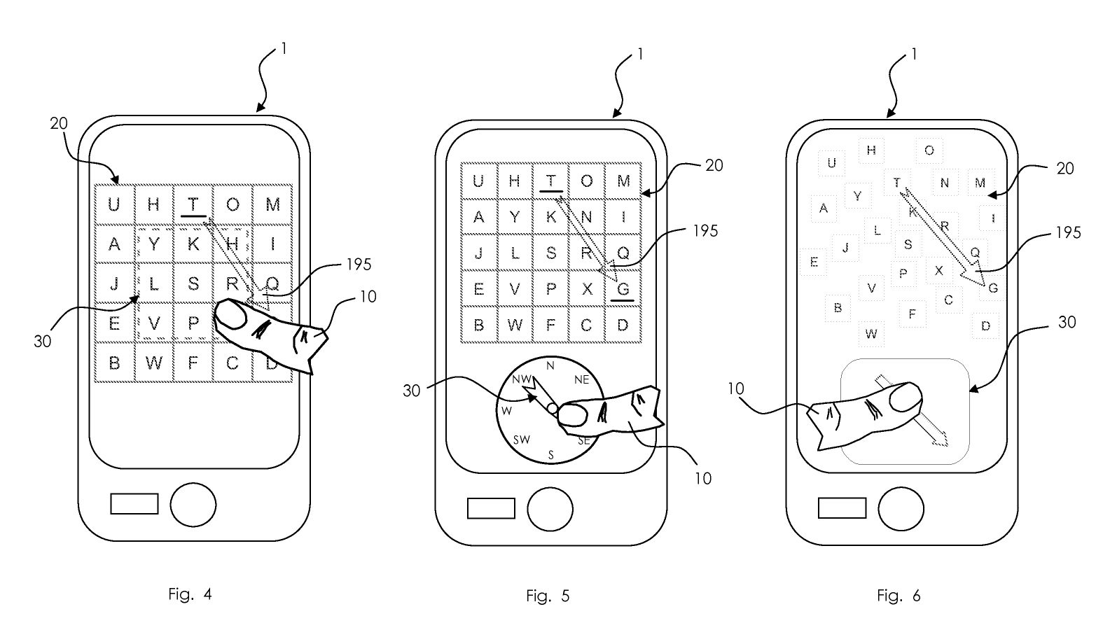

FIG. 4 illustrates a schematic illustration of the inventive system 1, showing a smartphone displaying the authentication characters in a two dimensional array or table, consisting of 25 characters, wherein an area of 3 by 3 elements or keys are touch sensitive, for entering the geometrical orientations by the subscriber.

FIG. 5 illustrates a schematic illustration of the inventive system 1, showing a smartphone, wherein an output unit displays randomly arranged characters in a two dimensional array or table, consisting of 25 unique characters, wherein the geometrical orientations from character “T” to character “G” of the authentication key is entered by steering a compass needle of the input unit of the system.

FIG. 6 illustrates a schematic illustration of the inventive system 1, showing a smartphone, wherein an output unit of said smartphone displays the authentication characters in an less structured over the output unit of the system array or table.

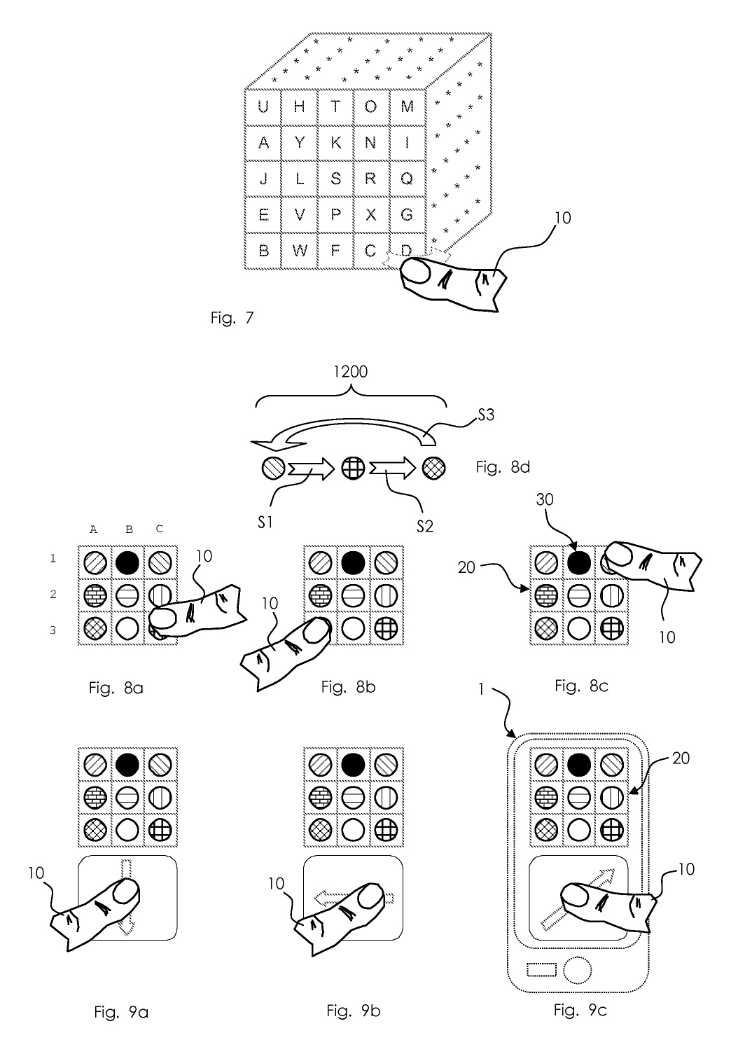

FIG. 7 illustrates yet another simplified schematic illustration of a user interface of the inventive system 1, wherein a cube is displaying a grid of five by five characters per side, wherein the cube is rotatable on eight axes, and wherein the subscriber selects and swipes the cube in the direction towards the succeeding character of the authentication key.

FIGS. 8a to 8c schematically illustrate an embodiment of the user interface, consisting of an output unit 20 and an input unit 30, e.g. implemented as a touch sensitive screen, of the inventive system 1. The subscriber or user selects the succeeding color and/or shade, which is geometrically related to a preceding color and/or shade and wherein for an authentication key of three colors and/or shades, the subscriber 10 quickly selects each of the three succeeding colors and/or shades, e.g. to unlock said screen of a device or system 1, such as a smartphone.

FIGS. 9a to 9c schematically illustrate a typical user interface of an embodiment of the inventive system 1, shown in FIG. 8c, wherein the subscriber 10 enters a geometrical orientation of successive shades of an authentication key shown in FIG. 8d of three shades, e.g. to unlock a screen of a portable device such as a smartphone. The subscriber has to remember only three successive shades as shown in FIG. 8d. He has to perform three steps for successful authentication.

### LIST OF REFERENCES

1 system
10 subscriber
120 storable authentication data
1200 authentication key
1201 authentication character
190 reference field
191 input field
195 first geometrical orientation
196 entered geometrical orientation
2 data station, communication terminal
20 output unit, output module
30 input unit, input module
301 input elements
4 service unit, server
40 authentication (central) unit, authentication module
50 storing unit
70 geometrical unit, topology unit
α angle
β angle
S1, S2, . . . step, sequence

1. A method for authentication of subscribers of a system, wherein an authentication key of a subscriber is transmitted from an input unit to an authentication unit of the system, and wherein the subscriber is authenticated by the authentication unit based on the transmitted authentication key by means of saved authentication data, wherein each of the authentication keys is composed of a subset of a predefined authentication character set, characterized in
that the system dynamically generates a multidimensional visual representation by geometrically arranging authentication characters of the authentication character set comprising successive characters of the authentication key, and displays said multidimensional visual representation by means of an output unit,
that first geometrical orientation of each pair of successive characters of the authentication key is determined by the subscriber within the visual representation and that said first geometrical orientation are entered by the subscriber for each of the pairs by means of the input unit of the system,
that each of the entered geometrical orientation is transmitted to the system, wherein second geometrical orientations are generated based on the visual representation,
that the first and second geometrical orientations are compared by means of the authentication unit, wherein on successful comparison the subscriber is authenticated if the first geometrical orientation matches the second geometrical orientation.

2. The method for authentication of subscribers according to claim 1, characterized in that the said multidimensional visual representation is two dimensional, wherein characters of the visual representation are arranged in a table.

3. The method for authentication of subscribers according to claim 1, characterized in that said multidimensional visual representation is three dimensional.

4. The method for authentication of subscribers according to claim 1, characterized in that the authentication character set is composed of alphanumerics, graphics and/or images.

5. The method for authentication of subscribers according to claim 1, characterized in that geometrical arrangement of authentication characters in the multidimensional visual representation is generated by means of the system by random.

6. The method for authentication of subscribers according to claim 1, characterized in that the system displays a subset of pairs of successive characters of the authentication key.

7. The method for authentication of subscribers according to claim 1, characterized in that the authentication key consist of identical successive characters, wherein only one of said characters is displayed within said multidimensional visual representation by the output unit of the system.

8. The method for authentication of subscribers according to claim 6, characterized in that the first geometrical orientation to said identical successive character is determined by the subscriber, and entered by means of the input unit.

9. The method for authentication of subscribers according to claim 1, characterized in that said input unit is a touch screen.

10. The method for authentication of subscribers according to claim 1, characterized in that said input unit is an alphanumeric keypad and/or keyboard.

11. The system for authentication of subscribers according to the method of claim 1, characterized in that the system comprises an output unit for displaying a multidimensional visual representation of authentications characters of an authentication character set, an input unit for entering first geometrical orientation by a subscriber, and an authentication unit for generating second geometrical orientation based on the visual representation and for authenticating said subscriber, if the first geometrical orientation matches the second geometrical orientation.
